(19) United States
(12) Patent Application Publication
(10) Pub. No.: US 2015/0077873 A1
(43) Pub. Date: Mar. 19, 2015

(54) ADHESIVE ARTICLES CONTAINING LIGHT SHIELDING FILM SUBSTRATES, METHOD OF MAKING THEREOF AND ARTICLES THEREFROM

(71) Applicant: 3M INNOVATIVE PROPERTIES COMPANY, ST. PAUL, MN (US)

(72) Inventors: Harry E. Johnson, Hudson, WI (US); Robert C. Fitzer, North Oaks, MN (US); Jeffry T. Omland, Waconia, MN (US)

(73) Assignee: 3M INNOVATIVE PROPERTIES COMPANY, ST. PAUL, MN (US)

(21) Appl. No.: 14/027,351

(22) Filed: Sep. 16, 2013

(51) Int. Cl. G02B 5/08; B32B 37/18; B32B 37/12

(52) U.S. Cl. CPC G02B 5/08; B32B 37/12; B32B 37/18; B32B 2405/00; B32B 2307/41; B32B 2307/416
USPC 359/871; 156/60

(57) ABSTRACT

Provided are adhesive articles and display components that include a film substrate and an adhesive. The film substrate includes a reflecting layer and an opaque layer. The adhesive may be disposed on at least one major surface of the reflecting layer and opaque layer. The inclusion of the film substrate in the adhesive articles enables the adhesive article to inhibit the transmission of visible light through the film substrate. The film substrate includes at least one cavity extending from the first major surface of the reflecting layer to the first major surface of the opaque layer, wherein the cavity volume is at least partially filled by the adhesive. The display component includes at least one display element adhered to an adhesive article via the adhesive. Methods of making adhesive articles and display components are also provided.

### TECHNICAL FIELD

The present invention relates generally to adhesive articles. In particular, the present invention relates to an adhesive article having a film substrate which includes a reflecting layer and an opaque layer. An adhesive may be disposed on a major surface of at least one of the reflecting layer and the opaque layer. The inclusion of the film substrate in the adhesive articles enables the adhesive article to inhibit the transmission of visible light through the film substrate.

### BACKGROUND

Adhesive articles, such as single sided and double sided tapes and transfer tapes, are used to bond a variety of substrates. Adhesive articles that may include an optically clear adhesive (OCA) are often used to bond various substrates in backlit signage and display assemblies, including large screen display formats, e.g. TV and computer displays, and small screen display formats, e.g. mobile handheld devices, such as, cellular phones, personal digital assistants (PDAs), electronic gaming devices, laptop computers, digital cameras and video cameras, global positioning systems (GPSs) and the like. For a variety of displays, including electronic displays, it is often desirable, for aesthetic purposes or other reasons, to include an opaque border or frame around part or all of the edge of the display. This border acts as a light shielding region, blocking light emanating from the display module, and is often used to obscure the view of the electronic circuitry around the edge of a touch screen display. It also provides an opportunity to incorporate indicia, which may facilitate the marketing of a particular brand of display or of the company that manufactures the display or associated electronic device housing the display. The opaque border is often fabricated by screen printing or coating of an ink or pigment, dispersed in an appropriate solvent and/or binder, along the edge of one of the display components.

In order to provide the appropriate amount of opacity, the opaque border may be about 25, 50, 100 or even 150 um in thickness. The current trend in the industry is for brighter displays and thinner displays. However, as display light intensity has increased, the thickness of the opaque border has had to increase in order to maintain the desired level of opacity of the screen border. This increase in the thickness of the opaque border results in an increase in the display thickness. Additionally, applying the opaque border creates additional processing steps for the display fabricators and the thickness of the border can lead to additional optical problems within the display.

The border, often called an ink step, leads to the formation of a gap, or air gap, in the display assembly. This gap creates undesired interfaces within the display assembly which can lead to a loss in display contrast. Consequently, display manufacturers have had to fill this gap with a material that has a refractive index that is more similar to that of the adjacent display components. The materials used to fill the gap, e.g. pressure sensitive adhesives (PSAs), often have difficulty conforming to the sharp corner where the vertical edge of the ink step intersects the horizontal surface of the substrate it is coated on. Consequently, small regions at the base of the ink step may not fill with PSA, leaving a visual defect, e.g. a bubble, in the display. This defect is unacceptable and leads to costly rework of the display assembly. To minimize this issue, thicker and softer PSAs have been used, but again, the use of thicker PSAs contradicts the desire to minimize the display thickness. Additionally, as display product design evolves towards thinner components, which are increasingly fragile, a need exists for new processes and corresponding materials that may be utilized at lower pressures and/or temperatures. Overall, there is a need for improved materials that are capable of one or more of the following: reducing the thickness of the opaque layer while maintaining the desired level of opacity of a display border or backlit signage, eliminating/minimizing the optical defects associated with filling of the gap created by the opaque border of a display, reducing the severity of the processing conditions used in display fabrication and reducing the number of assembly steps in the display assembly process.

### SUMMARY

In one aspect, the present disclosure relates to an adhesive article including a film substrate and a first adhesive. The film substrate includes i) a reflecting layer having first and second major surfaces, wherein incident electromagnetic radiation between the wavelengths of about 450 nm and about 750 nm reflecting from at least the first major surface of the reflecting layer has an average reflection of greater than about 50% and ii) an opaque layer having first and second major surfaces, wherein the second major surface of the opaque layer is positioned adjacent to the second major surface of the reflecting layer. The film substrate has an average transmission of less than about 20% of electromagnetic radiation between the wavelengths of about 450 nm and about 750 nm. The film substrate includes at least one cavity extending from the first major surface of the reflecting layer to the first major surface of the opaque layer. The cavity volume is at least partially filled by the first adhesive. Optionally, the first adhesive may be disposed on at least a portion of one of the first major surface of the reflecting layer and the first major surface of the opaque layer.

In another aspect, the present disclosure relates to a display component including the above disclosed adhesive article and a first display element adhered to the first adhesive.

In yet another aspect, the present disclosure relates to a method for producing a display component or display assembly. The method includes i) providing the above disclosed adhesive article, ii) providing a display element, and iii) adhering the display element to the first adhesive of the adhesive article.

The above summary of the present disclosure is not intended to describe each embodiment of the present invention. The details of one or more embodiments of the disclosure are also set forth in the description below. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 is a cross-sectional view of a film substrate according to the present disclosure.

FIG. 2 is a perspective, cross-sectional view of the film substrate according to the present disclosure including a cavity.

FIG. 3 is a perspective, cross-sectional view of a first embodiment of an adhesive article according to the present disclosure.

FIG. 4 is a perspective, cross-sectional view of a second embodiment of an adhesive article according to the present disclosure.

FIG. 5 is a perspective, cross-sectional view of a third embodiment of an adhesive article according to the present disclosure.

FIG. 6 is a perspective, cross-sectional view of a first embodiment of a display component according to the present disclosure.

FIG. 7 is a perspective, cross-sectional view of a second embodiment of a display component according to the present disclosure.

### DETAILED DESCRIPTION

### Definitions

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

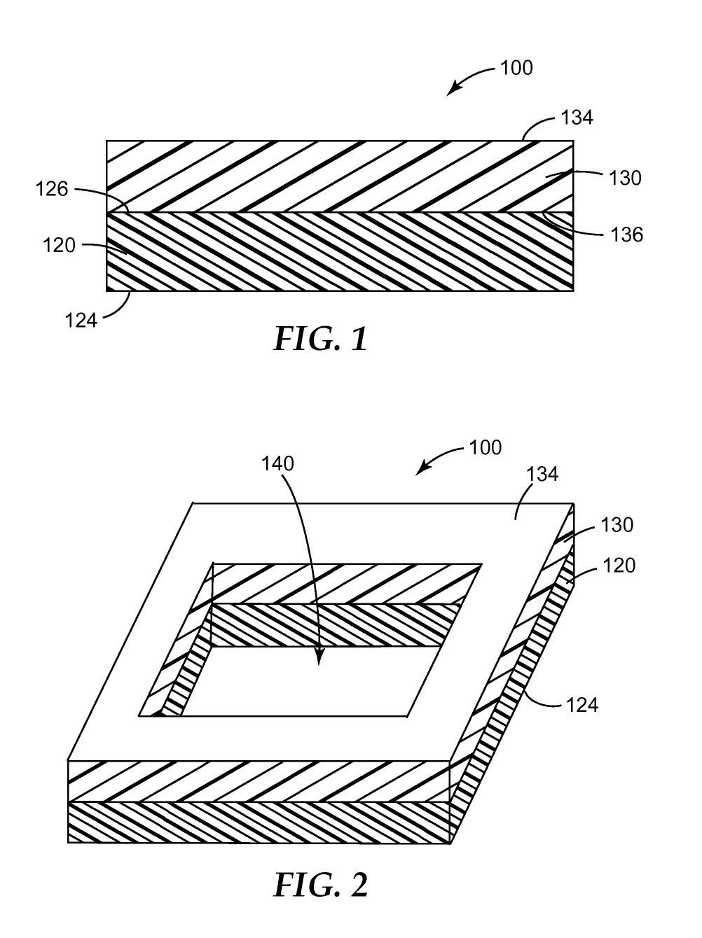

FIG. 1 shows a cross-sectional view of film substrate 100 of the present disclosure, which includes reflecting layer 120 having first major surface 124 and second major surface 126, and opaque layer 130 having first major surface 134 and second major surface 136. The reflecting layer and the opaque layer differ in their optical properties. In some embodiments, when the reflecting layer and opaque layer are combined to form the film substrate, the film substrate has an average transmission of less than about 20% of electromagnetic radiation between the wavelengths of about 450 nm and about 750 nm. In some embodiments, the film substrate has an average transmission of electromagnetic radiation between the wavelengths of about 450 nm and about 750 nm of less than about 10%, less than about 5%, less than about 1% or even less than about 0.1%. In some embodiments, the transmission of the electromagnetic radiation between the wavelengths of about 450 nm and about 750 nm of the film substrate is substantially 0%, i.e. all of the electromagnetic radiation is blocked by the film substrate. During use or during the measurement of the transmission of electromagnetic radiation through the film substrate, the film substrate may be configured relative to the radiation source such that radiation is incident to the first major surface of the reflecting layer. In this configuration, at least a portion of the radiation, e.g. light from a display module, will reflect off the reflecting layer. Thus, the portion of radiation transmitting through the film substrate is reduced significantly. The remaining radiation transmitting through the film substrate will then contact the opaque layer, where a significant portion of it will be absorbed and/or reflected by the opaque layer. The combined reflecting portion and absorbing portion of the film substrate produce a film substrate that has a low level of radiation transmittance between the wavelengths of about 450 nm and about 750 nm such that the film substrate may act as a light shielding component in a display, creating a light shielded region within the viewable region of the display.

In some embodiments, the film substrate may be a single layer having an average transmission of electromagnetic radiation between the wavelengths of about 450 nm and about 750 nm of less than about 20%, less than about 10%, less than about 5%, less than about 1% or even less than about 0.1%. In some embodiments, the transmission of the electromagnetic radiation between the wavelengths of about 450 nm and about 750 nm is substantially 0%, i.e. all of the electromagnetic radiation is blocked by the film substrate.

The reflecting layer of the film substrate typically reflects electromagnetic radiation in at least the visible region of the spectrum. In one embodiment, incident electromagnetic radiation between the wavelengths of about 450 nm and about 750 nm has an average reflection of greater than about 50%, greater than about 70%, greater than about 80% or even greater than about 90% from the reflecting layer. In another embodiment, incident electromagnetic radiation between the wavelengths of about 450 nm and about 750 nm reflecting from at least the first major surface of the reflecting layer has an average reflection of greater than about 50%, greater than about 70% or even greater than about 90%. In yet another embodiment, the first major surface of the reflecting layer reflects 100% of the electromagnetic radiation between the wavelengths of about 450 nm and about 750 nm. The reflecting layer can be made from materials known in the art, provided they produce the desired level of reflectance. The reflecting layer may be metal containing or non-metal containing. In some embodiments, the reflecting layer is a multi-layer optical film, a mirror film or a combination thereof.

Examples of multi-layer optical films are described in U.S. Pat. No. 5,882,774 (Jonza, et. al.), U.S. Pat. No. 6,157,490 (Wheatley, et. al.) and U.S. Pat. No. 6,368,699 (Gilbert, et. al.), all incorporated herein by reference. Multi-layer optical films (MOFs) generally include an optical stack having layers of a first material and layers of a second material. In one embodiment, each layer of the first and second materials has an average thickness of 1.0 micron or less and particularly 0.5 microns or less. In one embodiment, the first material is a semi-crystalline polymer and the second material is a polymer. The optical stack may be stretched, i.e. tentered, in at least one direction to at least twice that direction's unstretched dimension. The layers of the MOF have indices of refraction, nₓ and n_{y} in a plane of the layer and n_{z} normal to a plane of the layer. The indices of refraction of the various MOF layers are selected to provide desired optical properties, which may include a reflection of greater than about 50%, greater than about 70% or even greater than about 90% of the incident electromagnetic radiation between the wavelengths of about 450 nm and about 750 nm from at least a first major surface of the multi-layer optical film.

In general, appropriate combinations of materials may be achieved by selecting, as the first material, a crystalline or semi-crystalline, or liquid crystalline material, a polymer. The second material, in turn, may be crystalline, semi-crystalline, or amorphous. It should be understood that in the polymer art it is generally recognized that polymers are typically not entirely crystalline, and therefore in the context of the present invention, crystalline or semi-crystalline polymers refer to those polymers that are not amorphous and includes any of those materials commonly referred to as crystalline, partially crystalline, semi-crystalline, etc. In one embodiment, the second material has a birefringence opposite to or the same as that of the first material. In another embodiment, the second material has no birefringence.

Specific examples of suitable materials include, but are not limited to: polyethylene naphthalate (PEN) and isomers thereof (e.g., 2,6-, 1,4-, 1,5-, 2,7-, and 2,3-PEN), polyalkylene terephthalates (e.g., polyethylene terephthalate, polybutylene terephthalate, and poly-1,4-cyclohexanedimethylene terephthalate), polyimides (e.g., polyacrylic imides), polyetherimides, atactic polystyrene, polycarbonates, polymethacrylates (e.g., polyisobutyl methacrylate, polypropylmethacrylate, polyethylmethacrylate, and polymethylmethacrylate), polyacrylates (e.g., polybutylacrylate and polymethylacrylate), syndiotactic polystyrene (sPS), syndiotactic poly-alpha-methyl styrene, syndiotactic polydichlorostyrene, copolymers and blends of any of these polystyrenes, cellulose derivatives (e.g., ethyl cellulose, cellulose acetate, cellulose propionate, cellulose acetate butyrate, and cellulose nitrate), polyalkylene polymers (e.g., polyethylene, polypropylene, polybutylene, polyisobutylene, and poly(4-methyl)pentene), fluorinated polymers (e.g., perfluoroalkoxy resins, polytetrafluoroethylene, fluorinated ethylene-propylene copolymers, polyvinylidene fluoride, and polychlorotrifluoroethylene), chlorinated polymers (e.g., polyvinylidene chloride and polyvinylchloride), polysulfones, polyethersulfones, polyacrylonitrile, polyamides, silicone resins, epoxy resins, polyvinylacetate, polyether-amides, ionomeric resins, elastomers (e.g., polybutadiene, polyisoprene, and neoprene), and polyurethanes.

Other suitable materials include copolymers, for example: copolymers of PEN (e.g., copolymers of 2,6-, 1,4-, 1,5-, 2,7-, and/or 2,3-naphthalene dicarboxylic acid, or esters thereof, with (a) terephthalic acid, or esters thereof; (b) isophthalic acid, or esters thereof; (c) phthalic acid, or esters thereof; (d) alkane glycols; (e) cycloalkane glycols (e.g., cyclohexane dimethane diol); (f) alkane dicarboxylic acids; and/or (g) cycloalkane dicarboxylic acids (e.g., cyclohexane dicarboxylic acid)), copolymers of polyalkylene terephthalates (e.g., copolymers of terephthalic acid, or esters thereof, with (a) naphthalene dicarboxylic acid, or esters thereof; (b) isophthalic acid, or esters thereof; (c) phthalic acid, or esters thereof; (d) alkane glycols, (e) cycloalkane glycols (e.g., cyclohexane dimethanel diol); (f) alkane dicarboxylic acids; and/or (g) cycloalkane dicarboxylic acids (e.g., cyclohexane dicarboxylic acid)), and styrene copolymers (e.g., styrene-butadiene copolymers and styrene-acrylonitrile copolymers), 4,4′-bibenzoic acid and ethylene glycol. In addition, each individual layer may include blends of two or more of the above-described polymers or copolymers (e.g., blends of sPS and atactic polystyrene). The coPEN described may also be a blend of pellets where at least one component is a polymer based on naphthalene dicarboxylic acid and other components are other polyesters or polycarbonates, such as a PET, a PEN or a coPEN.

Particularly suitable combinations of layers, in the case of reflective films, include PET/Ecdel, PEN/Ecdel, PEN/sPS, PEN/THV, PEN/co-PET, and PET/sPS, where “co-PET” refers to a copolymer or blend based upon terephthalic acid (as described above), Ecdel is a thermoplastic polyester commercially available from Eastman Chemical Co., and THV is a fluoropolymer commercially available from 3M Company, St. Paul, Minn.

The number of layers in the multi-layer optical film is selected to achieve the desired optical properties for the reflecting layer using the minimum number of layers for reasons of film thickness, flexibility and economy. In some embodiments, the multi-layer optical film may have less than 10,000, less than 5,000, less 2,000 or even less than 1,000 layers. In some embodiments, the multi-layer optical film may have greater than 2, greater than 5, greater than 10, greater than 20, greater than 50, greater than 100 or even greater than 200 layers. In one embodiment, the multi-layer optical film has between about 2 layers and about 10,000 layers. In another embodiment, the multi-layer optical film has between about 50 layers and about 1,000 layers.

The ability to achieve the desired relationships among the various indices of refraction (and thus the optical properties of the multi-layer film) is influenced by the processing conditions used to prepare the multi-layer film. In the case of organic polymers which can be oriented by stretching, the films are generally prepared by co-extruding the individual polymers to form a multi-layer film and then orienting the film by stretching at a selected temperature, optionally followed by heat-setting at a selected temperature. Alternatively, the extrusion and orientation steps may be performed simultaneously. In the case of reflective films the film is stretched substantially in two directions (biaxial orientation). In one embodiment, the stretch ratio is from 1:2 to 1:10 and particularly 1:3 to 1:7 in the stretch direction and from 1:0.2 to 1:10 and particularly from 1:0.2 to 1:7 orthogonal to the stretch direction.

Examples of commercially available multi-layer optical films include, but are not limited to, enhanced specular reflective films available under the trade designation “VIKUITI ENHANCED SPECULAR REFLECTOR FILM (ESR)” from 3M Company, St. Paul, Minn.

In another embodiment, the reflecting layer may be a mirror film. Mirror films may be a metal film, metal foil or a metalized surface in which incident electromagnetic radiation between the wavelengths of about 450 nm and about 750 nm has an average reflection of greater than about 50%, greater than about 70% or even greater than about 90% from the mirror film surface. Although metal films or metal foils may be used, these materials may be adhered to one or more support substrates to allow for easier handling and to prevent defects in the metal film or metal foil surface. The support substrates may be any of those known in the art, for example, glass or polymer. The support substrate may be a polymeric substrate, including thermoplastic and/or thermoset films. The support substrate may be, for example: a crystalline or semicrystalline polymer, an amorphous polymer, a block copolymer, a crosslinked polymer, e.g. an elastomer, or a thermoplastic elastomer. The support substrate may include, for example: polyesters (e.g. polyetheylene terephthatle), polyolefins (e.g. polyethylene, polypropylene and the like), polycarbonates, polyamides (e.g. materials commonly referred to as nylon), polyurethanes, polyureas, polyacrylates, polymethacrylates, polyvinylchlorides, polysulfones, polyethersulfones, polyimides, epoxies and polysilicones. When a mirror film is used as the reflecting layer, particularly when the mirror film includes a support substrate, the mirror portion of the film substrate may be first major surface 124 and the support substrate may be second major surface 126.

The metal foil or metal film of the mirror film may be adhered to a support substrate by methods known in the art, including lamination. The metal foil or metal film may be laminated directly to a polymeric support substrate during formation of the polymeric substrate, which may occur via an extrusion process. In this case, adhesion between the metal foil or metal film and the polymeric support substrate may be acceptable. In other cases, an adhesive, such as a pressure sensitive adhesive, hot melt or thermoset, may be interposed between the metal film or metal foil and the support substrate to adhere the materials together. Adhesion primers/promoters for the metal surface and/or support substrate surface may also be used. Additionally, a metal coating may be deposited on the support substrate to form a metalized substrate surface having the desired reflection properties. Deposition of the metal may be conducted by methods known in the art, including vacuum deposition processes such as vacuum sputtering, physical vapor deposition and chemical vapor deposition. The mirror film may include at least one of silver, aluminum, gold, copper, indium tin oxide, tin, titanium, nickel and the like.

The thickness of the reflecting layer is selected in conjunction with the thickness of the opaque layer, based on the desired overall thickness of the film substrate. In one embodiment, the thickness of the reflecting layer is greater than about 1 micron, greater than about 5 microns, greater than about 10 microns or even greater than about 20 microns. In one embodiment, the thickness of the reflecting layer is less than about 200 microns, less than about 100 microns, less than about 80 microns or even less than about 50 microns.

The opaque layer of the film substrate typically has an average transmission of less than about 95% of the radiation in at least the visible region of the spectrum. In one embodiment, the opaque layer has an average transmission of less than about 95%, less than about 60%, less than about 50%, or even less than about 40% of the incident electromagnetic radiation between the wavelengths of about 450 nm and about 750 nm. In one embodiment, the opaque layer has an average transmission of greater than about 0.001%, greater than about 0.005%, greater than about 1%, greater than about 10% or even greater than about 20% of the incident electromagnetic radiation between the wavelengths of about 450 nm and about 750 nm. The opaque layer can be made from materials known in the art that produce the desired decrease in the transmission of electromagnetic radiation. In order to decrease the transmission of electromagnetic radiation in the visible region of the spectrum, the opaque layer may reflect a portion of the electromagnetic radiation, absorb a portion the electromagnetic radiation or may both reflect and absorb portions of the electromagnetic radiation. In some embodiments, the opaque layer is selected from an opaque film, an opaque coating or combination thereof.

The opaque layer may include an ink which may contain a pigment, dye, or combinations thereof. The ink may be in the form of a 100% solids coating. In one embodiment, the ink may have color shifting properties or specularly reflecting behavior. The ink coating may include reactive functional groups that may be cured and/or crosslinked by one or more of heat, high energy radiation, actinic radiation, e.g. UV radiation, and e-beam. The ink may be formed into an opaque coating by dispersing and/or dissolving a pigment and/or dye in an appropriate solvent (e.g. water), an organic solvent or combinations thereof, along with an optional binder. The opaque coating may then be coated directly on at least one surface of the reflecting layer. When the solvent is removed from the opaque coating, an opaque layer is formed on the surface of the reflecting layer. If a binder is used, it may be further cured or crosslinked by exposure to heat or actinic radiation, e.g. ultraviolet radiation. If the reflecting layer has a first major surface that is reflecting and a second major surface that is non-reflecting, the opaque coating is coated on the non-reflecting surface. The opaque coating may be coated onto the reflecting layer by any known method in the art, provided it yields the desired coating thickness on the surface of the reflecting layer. For example, coating may be conducted by roll coating, spraying coating, printing (e.g. ink jet printing, electrostatic printing, electrophotographic printing, screen printing, stencil printing or pad printing), rotor gravure coating, knife coating, curtain coating, metering rod coating (e.g. Meyer bar), flexographic printing and the like. Solvents used in the opaque coating include those typically used in the art, including, but not limited to: water, methanol, ethanol, propanol, heptane, toluene, tetrahydrofuran, methyl ethyl ketone, ethyl acetate and the like. The binder may be a polymeric binder, including, but not limited to: acrylates, epoxies, phenolics, polyesters, polyamides, polyurethanes and the like. The opaque coating may also be coated on a support substrate such as a polymeric substrate, and the reflecting layer may be laminated to or fabricated directly on the support substrate, typically the side opposite the opaque coating. For example, the opaque coating may be formed on a first major surface of a polymeric substrate and a mirror film may be deposited on a second major surface of the polymeric substrate.

The pigment and/or dye may also be dispersed in a polymeric material. The polymeric material may then be fabricated into a thin film, producing an opaque layer in the form of an opaque film. In one embodiment, the opaque film may have color shifting properties or specularly reflecting behavior. The opaque film may be adhered to the reflecting layer by any known method in the art. If the reflecting layer has a first major surface that is reflecting and a second major surface that is non-reflecting, the opaque film is adhered to the non-reflecting surface. The opaque film may be laminated directly to the reflecting layer during their formation via a co-extrusion process, such as co-extruding both the opaque film and a multi-layer optical film. The opaque film may be laminated directly to the reflecting layer during either one of their formation, e.g. the opaque film may be extruded directly on to a previously fabricated multi-layer optical film or mirror film. In these cases, adhesion between the opaque film and the reflecting layer may be acceptable. In other cases, an adhesive, such as a pressure sensitive adhesive, hot melt (including moisture cured hot melt) or thermoset, may be interposed between the opaque film and the reflecting layer to adhere the materials together. Adhesion primers/promoters for the opaque film and/or reflecting layer may also be used. The reflecting layer may also be fabricated directly on the opaque film. For example, a mirror film may be deposited on a major surface of the opaque film.

In some embodiments, the opaque layer provides color to the film substrate. This is particularly beneficial when the opaque layer may be visible in, for example, a display assembly that includes the film substrate of the present disclosure. The inks used in the opaque layer are selected based on desired qualities or attributes of the final product assembly. Consequently, inks that produce color in the visible region of the electromagnetic spectrum are typically used, for example: blue, green, yellow, orange, red and purple. Additionally, inks may be used that produce a black or a white colored opaque layer. Fluorescent dyes and pigments may also be used in the inks. Examples of commercially available colored dispersions include dispersions available under the trade designation SUPER SEATONE DISPERSIONS from Emerald Hilton Davis Company, Cincinnati, Ohio.

The thickness of the opaque layer is selected in conjunction with the thickness of the reflecting layer, based on the desired overall thickness of the film substrate. In some embodiments, the thickness of the opaque layer is greater than about 0.5 micron, greater than about 1 micron, greater than about 5 microns, greater than about 10 microns or even greater than about 20 microns. In some embodiments, the thickness of the opaque layer is less than about 200 microns, less than about 100 microns, less than about 80 microns or even less than about 50 microns. In some embodiments, the opaque layer has a thickness of between about 0.5 micron and about 200 microns.

When combined, the reflecting layer and the opaque layer form a film substrate having unique optical properties, including the ability to minimize the transmission of incident electromagnetic radiation, particularly incident electromagnetic radiation between the wavelengths of about 450 nm and about 750 nm. The inclusion of the opaque layer in the film substrate also enables the film substrate to provide aesthetic benefits to any final assembly that includes the film substrate, including a display assembly. In particular, the opaque layer can provide color to an assembly, a border or frame around an assembly and/or a means for incorporating indicia into an assembly.

Prior to incorporating film substrate 100 into an adhesive article, first major surface 124 of reflecting layer 120 and/or the first major surface 134 of opaque layer 130 (see FIGS. 1 and 2) may be protected from dust, debris and/or marring by a protecting layer, which may be a thin film such as a release liner or premask. Protecting layers, such as release liners and premasks, are known in the art and may be used without an included adhesive. They may also include an adhesive, e.g. a pressure sensitive adhesive, to improve the adhesion to the surface of the reflective layer and/or opaque layer. The protecting layer may also protect cavity 140 from dust and debris. The protecting layer is typically removed immediately prior to incorporating the film substrate into an adhesive article.

The thickness of the film substrate is selected based on the desired overall thickness of the final product in which it will be used. In some embodiments, the thickness of the film substrate is greater than about 1 micron, greater than about 5 microns, greater than about 10 microns, greater than about 20 microns or even greater than about 40 microns. In some embodiments, the thickness of the film substrate is less than about 1,000 microns, less than about 500 microns, less than about 250 microns, less than about 100 microns or even less than about 50 microns. In some embodiments, the film substrate has a thickness of between about 5 microns and about 250 microns.

The film substrate may include one or more cavities. FIG. 2 shows a perspective, cross-sectional view of film substrate 100 including reflecting layer 120, opaque layer 130, and cavity 140. Cavity 140 extends from first major surface 124 of reflecting layer 120 through first major surface 134 of opaque layer 130. Upon formation of cavity 140, a cavity volume is created in film substrate 100. The cavity volume is related to the thickness of film substrate 100 and the area of the major surface of the film substrate that has been removed. If more than one cavity exists in the film substrate, the total cavity volume of the film substrate is defined to be the sum of the volumes of the individual cavities contained within the film substrate. Unless otherwise indicated, when referring to the “cavity volume” herein, it is meant the total cavity volume of the film substrate.

The formation of the cavity allows electromagnetic radiation, in at least the visible region of the spectrum, to transmit substantially unabated through the film substrate in the cavity region. In some applications, there is no need to fill the cavity with another material. In other applications, e.g. if the film substrate is used in a display assembly, the cavity in the film substrate, along with the adjacent display components, may create an unwanted region of internal reflectance of light within the display assembly. Partially filling or substantially filling the cavity with an appropriate material that has a refractive index closer to those of the adjacent display component materials, as compared to air, may reduce the internal reflectance of light.

In some embodiments, at least a portion of the cavity volume may be filled by a polymeric material. In one embodiment, the polymeric material is an adhesive. In one embodiment, the polymeric material is optically clear. In this disclosure, a polymeric material is optically clear if it exhibits an optical transmission of at least about 90% and a haze value of less than about 5%, as measured on a 25 micron thick sample.

The cavity volume is at least partially filled. Particularly, greater than about 30%, greater than about 70%, greater than about 80%, greater than about 90% or even greater than about 95% of the cavity volume is filled. In some embodiments, the cavity volume is substantially filled.

By substantially filled, it is meant that greater than about 99% of the cavity volume is filled. In one embodiment, the cavity volume is filled by one polymeric material, such as an adhesive. In another embodiment, the cavity volume is filled by a first polymeric material and a second polymeric material, such as a first adhesive and a second adhesive. In some embodiments, the first and/or second adhesive may be optically clear. If the cavity volume is filled by a non-adhesive polymeric material, adhesives may be disposed on first major surface 124 of reflecting layer 120 and first major surface 134 of opaque layer 130 as well as the exposed surfaces of the polymeric material filling the cavity.

The number of cavities is not particularly limited and is selected with respect to the requirements of the end use application. The size and shape of each of the cavities are also not particularly limited and are selected with respect to the requirements of the end use application. For example, each cavity may be square, rectangular, triangular, hexagonal, octagonal, circular and the like. Each cavity may be letters or symbols used as indicia, for example, in backlit signage applications. A series of cavities may be formed randomly in the film substrate or into a pattern in the film substrate. The pattern of cavities may be used to create letters, words, shape, symbols and/or desired indicia in the film substrate. Combinations of cavity shapes may be used. In display assembly applications, a single cavity that is substantially rectangular or square in shape may be used, with the remaining film substrate providing a border or frame around the outer edge of the display assembly.

The cavities may be formed in the film substrate by known techniques in the art, taking into account the materials that make up the film substrate and the thickness of the film substrate.

The cavities can be formed, for example, by die cutting, water jet cutting, laser cutting and the like. If either the reflecting layer or the opaque layer includes a protecting layer, the cavities can also be formed by kiss cutting.

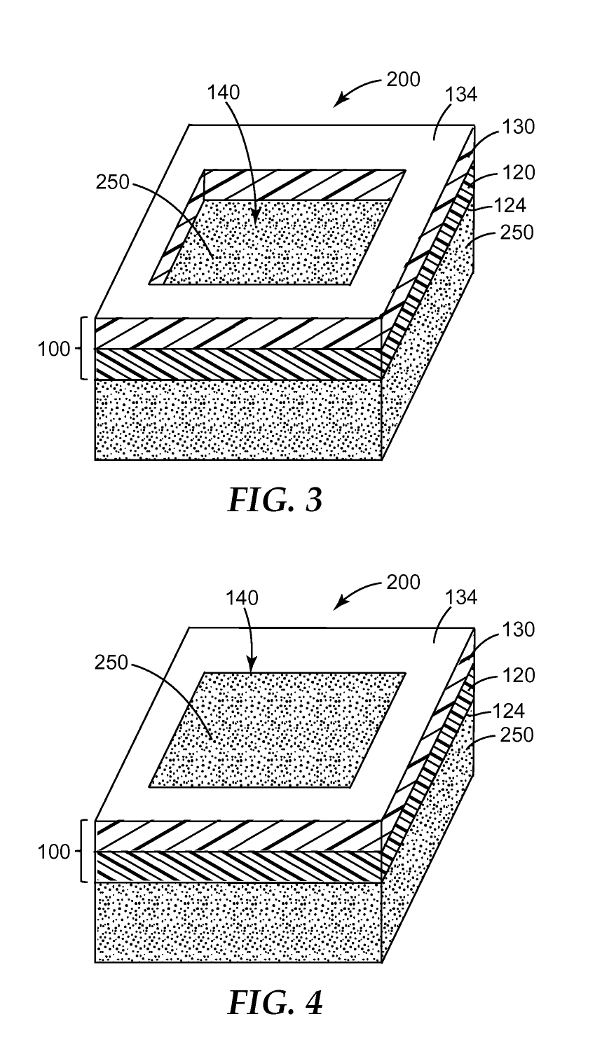

An adhesive article may be formed by disposing an adhesive on the first major surface of the reflecting layer, disposing an adhesive on the first major surface of the opaque layer or disposing adhesive on both the first major surface of the reflecting layer and the first major surface of the opaque layer. FIG. 3 shows a perspective, cross-sectional view of a first embodiment of adhesive article 200, including film substrate 100, cavity 140 and first adhesive 250 disposed on first major surface 124 of reflecting layer 120. As can be seen in FIG. 3, first adhesive 250 partially fills cavity 140. FIG. 4 shows a perspective, cross-sectional view of a second embodiment of adhesive article 200 including film substrate 100, cavity 140 and first adhesive 250 disposed on first major surface 124 of reflecting layer 120. In this embodiment, first adhesive 250 substantially fills cavity 140.

In another embodiment, cavity 140 of film substrate 100 (see FIG. 2) is at least partially filled with a first adhesive. In yet another embodiment, a first adhesive fills cavity 140 and a second adhesive is disposed on at least one of first major surface 124 of reflecting layer 120 and first major surface 134 of opaque layer 130 and optionally, on the exposed surface of the first adhesive filling cavity 140. In one embodiment, if the second adhesive is disposed on first major surface 124 of reflecting layer 120 and optionally, on the exposed surface of the first adhesive filling cavity 140, a third adhesive may be disposed on first major surface 134 of opaque layer 130, and optionally, on the exposed surface of the first adhesive filling cavity 140.

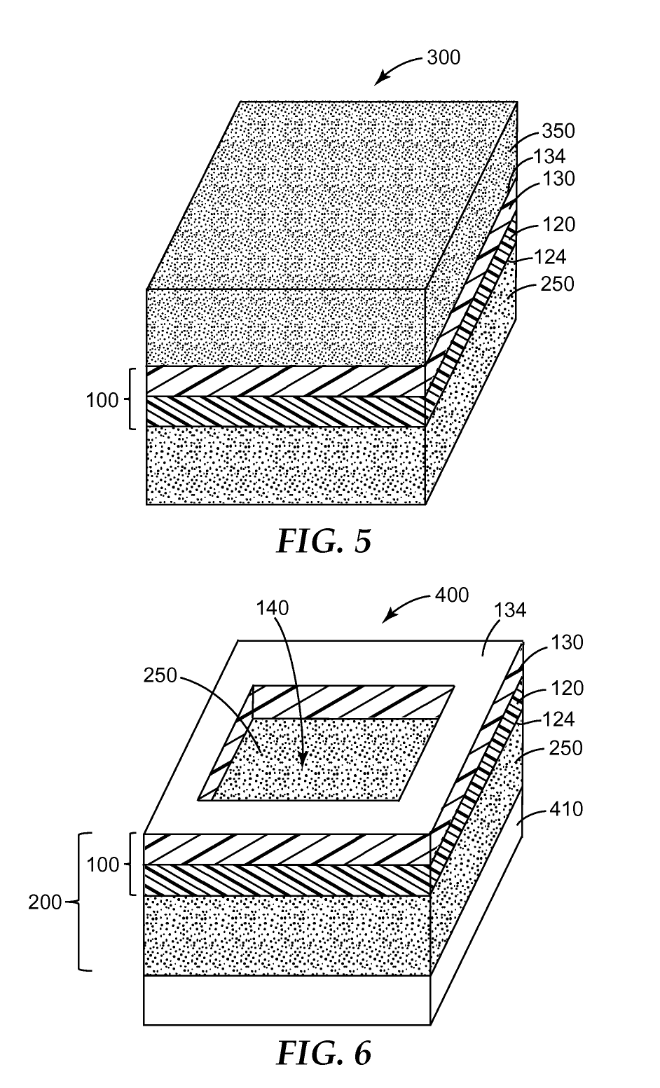

FIG. 5 shows a perspective, cross-sectional view of adhesive article 300 including film substrate 100, first adhesive 250 disposed on first major surface 124 of reflecting layer 120 and second adhesive 350 disposed first major surface 134 of opaque layer 130. If film substrate 100 includes at least one cavity (not shown), at least one of first adhesive 250 and second adhesive 350 may at least partially fill the cavity volume. In some embodiments, both first adhesive and second adhesive at least partially fill the cavity volume. The first adhesive and the second adhesive may be the same adhesive or different adhesives. The adhesives of the adhesive article may be temporarily attached to one or more release liners. For example, in some embodiments, the adhesive article may include a first release liner disposed on the exposed surface of the first adhesive. In another embodiment, the adhesive article may include a first release liner disposed on the exposed surface of the first adhesive and the second adhesive. Any release liners known in the art may be used, provided they provide the desired release characteristics. For example, if the first adhesive and the second adhesive are optically clear adhesives, removal of the associated release liners should occur without creating a visual defect in the optically clear adhesive.

Each of the adhesive may be any known in the art, provided it meets the requirements of the end use application. The first, second and third adhesives may be the same or may be different. In some embodiments, the adhesives may be selected from at least one of a pressure sensitive adhesive, a structural or elastomeric thermoset adhesive and heat activated adhesive, such as hot melt adhesives. In some embodiments, the adhesives may be an optically clear adhesive.

Pressure sensitive adhesives that may be used in the adhesive articles of the present disclosure include, but are not limited to, those based on acrylates, silicones, nitrile rubber, butyl rubber, natural rubber, stryrene block copolymers, urethane and the like. Pressure sensitive adhesives based on poly(meth)acrylates are particularly suitable. In one embodiment, the pressure sensitive adhesives are optically clear. Suitable examples of such optically clear pressure sensitive adhesives are described, for example, in U.S. Pat. No. 8,361,632 (Everaerts, et. al.) and U.S. Pat. No. 8,361,633 (Everaerts, et. al.), U.S. Pat. Publ. Nos. 2009/087629 (Everaerts, et. al.), 2010/0040842 (Everaerts, et. al.), 2010/0136265 (Everaerts, et. al.), and PCT publication WO 2012/112856 (Xia, et. al.), all incorporated herein by reference.

When the pressure sensitive adhesive is in the form of a film the pressure sensitive adhesive may be disposed on the first major surface of the reflecting layer and/or the first major surface of opaque layer through, for example, a lamination process, forming an adhesive article. During this process, the pressure adhesive may at least partially fill one or more cavities in the film substrate. The pressure sensitive adhesive may also be cut to a similar size of that of the cavity in order to be placed in and fill the cavity, forming an adhesive article. The pressure sensitive adhesive may be in the form of a transfer tape, i.e. a pressure sensitive adhesive positioned between release liners, either a single release liner, wherein both the front and back side of the release liner contact the pressure sensitive adhesive via a roll of tape or two separate release liners. Commercially available transfer tapes include those available under the trade designation “3M CONTRAST ENHANCEMENT FILMS”, “3M OPTICALLY CLEAR LAMINATING ADHESIVES” and “3M OPTICALLY CLEAR ADHESIVES”; including the 8100 product series, e.g. 8146, 8171, 8187 and the like, the 8200 product series, e.g. 8211, 8213, 8215 and the like, and product number 9483; all available from 3M Company, St. Paul, Minn. When at least one release liner is removed to expose the surface of the pressure sensitive adhesive, the pressure sensitive adhesive may be laminated to the first major surface of the reflecting layer and/or the first major surface of opaque layer. The remaining release liner may stay with the adhesive article, to protect the adhesive surface, until time of use. When the adhesive is applied in the form of a transfer tape, the thickness of the adhesive, the modulus and/or the viscoelastic properties of the adhesive may influence the ability of the adhesive to fill a cavity volume of the film substrate. The thickness of the film substrate will determine the depth of the cavity. Subsequently, as the cavity depth increases, generally, it may be desired to have a thicker adhesive or a lower modulus adhesive or even an adhesive capable of viscous flow, in order to facilitate filling of the cavity volume by the adhesive. The pressure sensitive adhesive may be laminated under conditions of elevated temperature and/or pressure to facilitate filling of the cavity volume by the adhesive. The pressure sensitive adhesive may be laminated under conditions of elevated temperature and/or vacuum to facilitate filling of the cavity volume by the adhesive. Vacuum lamination techniques may be particularly beneficial when the adhesive article includes both a first and second adhesive.

In some embodiments, the pressure sensitive adhesive may be formed in an in-situ process from a polymerizable syrup or a polymerizable monomer solution. The pressure sensitive adhesive may then be disposed on the first major surface of the reflecting layer and/or the first major surface of the opaque layer through an in-situ coating and curing process, forming an adhesive article. During this process, the adhesive may also be dispensed to at least partially fill one or more cavities in the film substrate. Suitable examples of pressure sensitive adhesives formed from a polymerizable syrup are described, for example, in U.S. Pat. No. 4,181,752 (Clemens, et. al), U.S. Pat. No. 4,364,972 (Moon), U.S. Pat. No. 5,028,484 (Martin, et. al.), U.S. Pat. No. 5,612,136 (Everaerts, et. al.) U.S. Pat. No. 5,708,109 (Bennett, et. al.), U.S. Pat. No. 5,840,783 (Momchilovich, et. al.), U.S. Pat. No. 5,883,193 (Karim), U.S. Pat. No. 7,463,417 (Duncan, et. al.), U.S. Pat. No. 8,361,632 (Everaerts, et. al.), U.S. Pat. Publ. Nos. 2004/0137222 (Welke, et. al.) and 2009/087629 (Everaerts, et. al.) and PCT publication WO 2012/112856 (Xia, et. al.), all incorporated herein by reference. A polymerizable syrup includes a mixture of one or monomers, oligomers and low molecular weight polymers that is formed by partially polymerizing a single, specific monomer/monomer mixture and associated cure initiator(s) and/or cure agent(s), that will form a pressure sensitive adhesive upon additional polymerization. Typically, the initial monomer/monomer mixture will be partially polymerized, for example by exposure to UV radiation, yielding a polymerizable syrup that has a viscosity between about 300 cps and about 50,000 cps at room temperature. Other components may be added to the polymerizable syrup, such as, additional monomers, crosslinking agents, oligomers or polymers soluble in the syrup. Oligomers and polymers, soluble in the original monomer/monomer mixture, may optionally be added to the monomer/monomer mixture prior to partial polymerization. The polymerizable syrup may be coated on the film substrate and subsequently exposed to heat and/or radiation, e.g. UV radiation, to further polymerize the syrup and form a pressure sensitive adhesive. If the film substrate has at least one cavity, the polymerizable syrup may partially fill or substantially fill the cavity during the coating process, while optionally being disposed on the first major surface of the reflecting layer and/or the first major surface of opaque layer. Upon further polymerization of the syrup, the cavity volume is at least partially filled by the formed pressure sensitive adhesive. The polymerizable syrup may be coated under conditions of reduced pressure, i.e. vacuum, to facilitate filling of the cavity volume by the polymerizable syrup and the subsequently formed pressure sensitive adhesive. In some embodiments, the polymerizable syrup will form an optically clear pressure sensitive adhesive.

Additionally, the polymerizable syrup may be coated between release liners and polymerized to form a pressure sensitive adhesive film in a transfer tape format. The pressure sensitive adhesive may then be disposed on the first major surface of the reflecting layer and/or the first major surface of opaque layer through a lamination process, as previously discussed.

In other embodiments, the pressure sensitive adhesive may be formed in an in-situ process from a polymerizable monomer solution. A polymerizable monomer solution includes a mixture of one or monomers and associated cure initiator(s) and/or cure agent(s), and optional oligomers and/or polymers soluble in the monomer mixture, that will form a pressure sensitive adhesive upon curing. The polymerizable monomer solution may be coated on the film substrate and subsequently exposed to heat and/or radiation, e.g. UV radiation, to cure the polymerizable monomer solution and form a pressure sensitive adhesive. If the film substrate has at least one cavity, the polymerizable monomer solution may partially fill or substantially fill the cavity during the coating process, while optionally being disposed on the first major surface of the reflecting layer and/or the first major surface of opaque. Upon further polymerization of the monomer solution, the cavity volume is at least partially filled by the formed pressure sensitive adhesive. The polymerizable monomer solution may be coated under conditions of reduced pressure, i.e. vacuum, to facilitate filling of the cavity volume by the polymerizable monomer solution and the subsequently formed pressure sensitive adhesive. In some embodiments, the polymerizable monomer solution will form an optically clear pressure sensitive adhesive. In this case, the monomer mixture is sometimes called a liquid optically clear adhesive (LOCA).

Suitable examples of such LOCAs are described, for example, in PCT publications WO 2010/111316 (Busman, et. al.) and WO 2012/087804 (Everaerts, et. al.), both incorporated herein by reference. Although the polymerizable monomer solutions may form a pressure sensitive adhesive, other polymerizable monomer solutions may form a non-tacky adhesive film.

Heat activated adhesives are adhesives that may act as an adhesive, e.g. a pressure sensitive adhesive or structural adhesive, at ambient or use temperature, while having the ability to flow, similar to a liquid, at an elevated temperature. Heat activated adhesives include hot melt adhesives, adhesives that are semi-crystalline or amorphous and have the ability to flow when they are heated to a temperature above their crystalline melting temperature, Tm, and/or above their glass transition temperature, Tg. Once cooled back to a temperature below their Tm and/or Tg, the hot melt adhesive solidifies and provides adhesive properties. The hot melt adhesive may include at least one of a polyurethane, polyamide, polyester, polyacrylate, polyolefin, polycarbonate and epoxy resin. The hot melt adhesive may be capable of being cured. Curing the hot melt adhesive may comprise at least one of moisture curing, thermal curing and actinic radiation curing. Heat activated adhesives may include the adhesives disclosed in U.S. Pat. Publ. No. 2012/0325402 (Suwa, et. al.) and U.S. Pat. No. 7,008,680 (Everaerts, et. al.) and U.S. Pat. No. 5,905,099 (Everaerts, et. al.), all incorporated herein by reference.

Heat activated adhesives may be laminated to the film substrate, forming an adhesive article. Heat activated adhesives may be laminated to the film substrate under conditions of elevated temperature and, optionally pressure. In this process, the heat activated adhesives may be in the form of a film. The temperature used is generally determined by the flow temperature of the heat activated adhesive, which may be related to the Tm and/or Tg of the heat activated adhesive or a corresponding component therein. Generally, the lamination will occur at a temperature above the flow temperature that allows the adhesive sufficient flow, while not adversely affecting the film substrate. In some cases, the heat activated adhesive may be laminated under conditions of elevated temperature and/or reduced pressure, i.e. vacuum, to facilitate filling of the cavity volume by the adhesive. In some embodiments, if the film substrate of the adhesive article includes a cavity, the heat activated adhesive may flow during the lamination process, allowing the cavity volume to be at least partially filled by the adhesive.

The heat activated adhesive may also be cut to a similar size of that of the cavity in order to be placed in and fill the cavity, forming an adhesive article. The heat activated adhesive may flow during this process, allowing the cavity volume to be at least partially filled by the adhesive. During flow, the heat activated adhesive may also coat or be disposed on the first major surface of the reflecting layer and/or the first major surface of opaque.

The thickness of the adhesive is selected based on the desired overall thickness of the final product in which it will be used and, when a cavity is present in the film substrate, on the thickness of the film substrate, if the adhesive at least partially fills or substantially fills the cavity volume. In one embodiment, the thickness of the adhesive is greater than about 5 microns, greater than about 10 microns, greater than about 20 microns or even greater than about 40 microns. In one embodiment, the thickness of the adhesive is less than about 500 microns, less than about 200 microns, less than about 100 microns, less than about 75 microns or even less than about 50 microns.

To further optimize adhesive performance of the adhesive, adhesion promoting additives, such as silanes and titanates, may also be incorporated into the adhesives of the present disclosure. Such additives can promote adhesion between the adhesive and the substrates, for example, adhesion between the glass and cellulose triacetate of an LCD, by coupling to the silanol, hydroxyl, or other reactive groups in the substrate. The silanes and titanates may have only alkoxy substitution on the Si or Ti atom connected to an adhesive copolymerizable or interactive group. Alternatively, the silanes and titanates may have both alkyl and alkoxy substitution on the Si or Ti atom connected to an adhesive copolymerizable or interactive group. The adhesive copolymerizable group is generally an acrylate or methacrylate group, but vinyl and allyl groups may also be used. Alternatively, the silanes or titanates may also react with functional groups in the adhesive, such as a hydroxyalkyl(meth)acrylate. In addition, the silane or titanate may have one or more group providing strong interaction with the adhesive matrix. Examples of this strong interaction include hydrogen bonding, ionic interaction, and acid-base interaction. An example of a suitable silane includes, but is not limited to, (3-glycidyloxypropyl)trimethoxy silane.

The pressure sensitive adhesive can be inherently tacky. If desired, tackifiers can be added to the precursor mixture before formation of the pressure sensitive adhesive. Useful tackifiers include, for example, rosin ester resins, aromatic hydrocarbon resins, aliphatic hydrocarbon resins, and terpene resins. In general, light-colored tackifiers selected from hydrogenated rosin esters, terpenes, or aromatic hydrocarbon resins can be used.

Other materials can be added to the adhesives, typically during their fabrication, for special purposes, including, for example, oils, plasticizers, antioxidants, UV stabilizers, corrosion inhibitors, pigments, curing agents, polymer additives, viscosity modifiers, e.g. thixotropic agents such as fumed silica and clay, organic and inorganic nanoparticles and other additives provided that they do not significantly reduce the desired properties, e.g. optical clarity, of the pressure sensitive adhesive.

In one embodiment, a method of making an adhesive article of the present disclosure includes providing a film substrate including a reflecting layer having a first major surface and a second major surface and an opaque layer having a first major surface and a second major surface, wherein the second major surface of the opaque layer is positioned adjacent to the second major surface of the reflecting layer, forming one or more cavities extending from the first major surface of the reflecting layer to the first major surface of the opaque layer; providing a first adhesive; disposing the first adhesive on at least a portion of at least one of the first major surface of the reflecting layer and the first major surface of the opaque layer; and filling the cavity volume at least partially by the first adhesive. In one embodiment, the cavity volume is substantially filled by the first adhesive.

In yet another embodiment, a method of making an adhesive article includes providing a film substrate including a reflecting layer having a first major surface and a second major surface and an opaque layer having a first major surface and a second major surface, wherein the second major surface of the opaque layer is positioned adjacent to the second major surface of the reflecting layer, cutting one or more cavities extending from the first major surface of the reflecting layer to the first major surface of the opaque layer, providing a polymerizable syrup; coating the polymerizable syrup on at least a portion of at least one of the first major surface of the reflecting layer and the first major surface of the opaque layer, filling the cavity volume at least partially by the polymerizable syrup; and polymerizing the polymerizable syrup to form a first adhesive, e.g. a pressure sensitive adhesive. In some embodiments, the cavity volume is substantially filled by the polymerizable syrup and, upon polymerization, the cavity volume is substantially filled by the adhesive. In the above method, the polymer syrup may be replaced by a polymerizable monomer solution.

Additionally, the polymerizable monomer solution and polymerizable syrup composition may be adjusted such that, after polymerizing, a non-tacky polymer is formed. In this case, it is preferred to dispose at least one adhesive on at least one of the reflecting layer and the opaque layer. The adhesive may be made by an in-situ coating and curing process using a polymerizable syrup or polymerizable monomer solution or, may be in the form of a pressure sensitive adhesive transfer tape which may be laminated to the reflecting layer and the opaque layer.

In another embodiment, a method of making an adhesive article includes providing a film substrate including a reflecting layer having a first major surface and a second major surface and an opaque layer having a first major surface and a second major surface, wherein the second major surface of the opaque layer is positioned adjacent to the second major surface of the reflecting layer, cutting one or more cavities extending from the first major surface of the reflecting layer to the first major surface of the opaque layer, providing a heat activated adhesive; laminating the heat activated adhesive on at least a portion of at least one of the first major surface of the reflecting layer and the first major surface of the opaque layer under conditions of elevated temperature such that the heat activated adhesive flows; filling the cavity volume at least partially by the heat activated adhesive; and optionally, cooling the heat activated adhesive to room temperature.

In any of the disclosed methods of making an adhesive article, the method may further include the steps of: providing a second adhesive and disposing the second adhesive on at least a portion of at least one of the first major surface of the reflecting layer and the first major surface of the opaque layer. In some embodiments, when the first adhesive is disposed on the first major surface of the reflecting layer, the second adhesive is disposed on the first major surface of the opaque layer. In other embodiments, when the first adhesive is disposed on the first major surface of the opaque layer, the second adhesive is disposed on the first major surface of the reflecting layer. The adhesives and their corresponding deposition techniques may be the same or different. For example, when the first adhesive is one of a pressure sensitive adhesive, a polymerizable syrup, a polymerizable monomer solution and a heat activated adhesive; the second adhesive may be one of a pressure sensitive adhesive, a polymerizable syrup, a polymerizable monomer solution and a heat activated adhesive. In some embodiments, the cavity volume may be at least partially filled by the second adhesive. In some embodiments, the cavity volume may be substantially filled by the first adhesive and second adhesive. The method of making an adhesive article may include lamination and/or coating techniques that include the use of elevated temperature, pressure and combinations thereof or elevated temperature, reduced pressure, i.e. vacuum, and combinations thereof.

One of ordinary skill art will recognize that the adhesive articles of the present disclosure may be formed by a variety of methods, including those described above. It should be understood, however, that many variations and modifications to these methods may be made while remaining within the scope of the present disclosure.

The adhesive articles of the present disclosure may be used to form display components by adhering a display element to the adhesive article via the adhesive of the adhesive article. In one embodiment, a display component includes an adhesive article having a first adhesive and a first display element adhered to the first adhesive. FIG. 6 shows display component 400 including adhesive article 200 and first display element 410. Adhesive article 200 includes film substrate 100 having reflecting layer 120, opaque layer 130 and first adhesive 250. First adhesive 250 is adhered to the first major surface 124 of reflecting layer 120 and partially fills cavity 140. Although FIG. 6 depicts first adhesive 250 as only partially filling cavity 140, in some embodiments, first adhesive 250 may substantially fill cavity 140. First display element 410 is adhered to adhesive article 200 through first adhesive 250. In another embodiment, first adhesive 250 may be disposed on first major surface 134 of opaque layer 130, instead of first major surface 124 of reflecting layer 120. First display element 410 may then be adhered to adhesive article 200 through first adhesive 250 disposed on first major surface 134 of opaque layer 130.

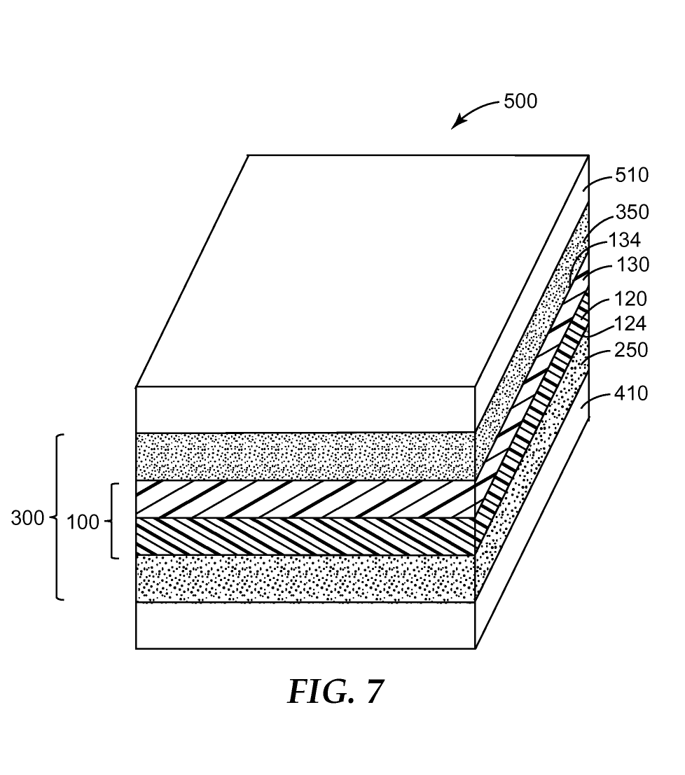

In yet another embodiment, a display component includes an adhesive article having a first adhesive, a second adhesive, a first display element adhered to the first adhesive and a second display element adhered to the second adhesive. FIG. 7 shows a display component 500 which includes adhesive article 300. Adhesive article 300 includes film substrate 100 having reflecting layer 120 and opaque layer 130 with first adhesive 250 disposed on first major surface 124 of reflecting layer 120 and second adhesive 350 disposed on first major surface 134 of opaque layer 130. Film substrate 100 may include a cavity, not shown. If film substrate 100 includes at least one cavity, at least one of first adhesive 250 and second adhesive 350 may at least partially fill or substantially fill the cavity volume. In some embodiments, both first adhesive 250 and second adhesive 350 at least partially fill or substantially fill the cavity volume. First display element 410 is adhered to adhesive article 300 through first adhesive 250. Second display element 510 is adhered to adhesive article 300 through second adhesive 350.

Prior to incorporating adhesive article 200 or 300 into a display component, the surface of first adhesive 250 that is not adhered to film substrate 100 and the surface of second adhesive 350 that is not adhered to film substrate 100, if used, may be protected from dust, debris and/or marring by a protecting layer, which may be a thin film, e.g. a release liners. Protecting layers, such as release liners, are known in the art. The protecting layer is typically removed immediately prior to incorporation the adhesive article into a display component.

The display element(s) used in the display components of the present disclosure may be any known in the art. For example, the display element may be selected from at least one of a display module, camera module, protective layer, polarizer, optical filter (e.g. ultra violet and infrared notch filter reflective film), anti-reflective film, hard coat film, contrast enhancement film, privacy film and EMI/RF shielding layer. Any of the display elements may be optically clear. In one embodiment, the display module may be part of an electronic device and include an image forming component. Generally, the image-forming region of a display module is that region which includes means for rendering information in the form of images, figures, or text. In electronic display modules, the information is typically changeable. In some embodiments, the image-forming region can also be touch-sensitive, i.e. the display module includes a touch screen display. In one embodiment, the display module may be an electronic display module. An electronic display module can be any visible display of information that is a part of or in electronic communication with an electronic device. Examples of electronic display modules include, but are not limited to: flat panel displays that contain electroluminescent (EL) lamps, light-emitting diodes (LEDs), organic light-emitting diodes (OLEDs), or and plasma components that create visible radiation—usually in a matrix display. Other examples of electronic display modules include reflective or backlit liquid crystal displays (LCD). Yet other examples of electronic display modules include reflective displays such as electrophoretic (EP) displays or electrowetting displays. The display module has a viewable or image-forming region which may comprise the whole area of the display module or some part of the display module that can be viewed, for example, through an opening in a housing or through a frame or border. For example, a film substrate of the present disclosure having the same general length and width of a display module may be fabricated with a cavity having a somewhat smaller length and width. When adhered to the display module, with the periphery of the film substrate aligned with the periphery of the display module, the film substrate with cavity may provide a frame or border, i.e. a light shielding region, around the edge of the display module, via the associated opaque layer and reflecting layer.

The protective layer used as a display component is not particularly limited as long as it may be used as a protective film suitable for protecting other members of the display component. The protective layer may be composed of a polymer film or a glass plate, or may be composed of plurality of layers. For example, the protective layer may be an acrylic resin film made of polymethyl methacrylate (PMMA), a polycarbonate resin film, cyclic polyolefin film, cellulose triacetate (TAC) film, polyethylene terephthalate (PET), polyethylene naphthalate (PEN) or a glass plate. The thickness of the film or glass plate is not particularly limited and is usually from 0.1 to 5 mm. The protective layer may be a cover glass or lens of a handheld device. The protective layer may be flat, may be curved or may contain topographical features. When the protective layer is a laminate composed of a plurality of layers, it is possible to provide a layer for imparting functions and characteristics such as abrasion resistance, scratch resistance, antifouling properties, anti-reflective properties and antistatic properties.

In one embodiment, a method of making a display component includes providing an adhesive article according to the present disclosure, providing a first display element, and adhering the first display element to the adhesive article via an adhesive of the adhesive article.

In another embodiment, a method of making a display component includes providing an adhesive article having a first adhesive and a second adhesive, providing a first display element, adhering the first display element to the adhesive article via the first adhesive, providing a second display element and adhering the second display element to the adhesive article via the second adhesive.

### EXAMPLES

The articles and methods of the present disclosure will be further described with regard to the following detailed examples. These examples are offered to further illustrate the various specific and preferred embodiments and techniques. It should be understood, however, that many variations and modifications may be made while remaining within the scope of the present disclosure.

### Materials

Materials

| Abbreviation | |
|---|---|
| or | |
| Trade Name | Description |
| OCA8146-1 | An optically clear, acrylic adhesive, available under the |
| | trade designation “3M OPTICALLY CLEAR ADHESIVE |
| | 8146-X” from 3M Company, St. Paul, Minnesota. |
| OCA8187 | An optically clear, acrylic, laminating adhesive, available |
| | under the trade designation “3M OPTICALLY CLEAR |
| | ADHESIVE 8187” from 3M Company. |
| ESR2 | A 1.25 mil (32 micron) enhanced specular reflective film |
| | available under the trade designation “VIKUITI |
| | ENHANCED SPECULAR REFLECTOR FILM (ESR 2)” |
| | from 3M Company. |
| Disp1 | A white, liquid dispersion, available under the trade |
| | designation “SUPER SEATONE TITANIUM DIOXIDE”, |
| | product number 6C11B003, from Emerald Hilton Davis |
| | Company, Cincinnati, Ohio. |
| Disp2 | A black, liquid dispersion, available under the trade |
| | designation “SUPER SEATONE TINTING BLACK”, |
| | product number 6C11B704, from Emerald Hilton Davis |
| | Company. |
| PET 1 | A 2 mil (51 micron) thick poly(ethylene terephtahlate) |
| | film, available under the trade designation “DUPONT |
| | TEIJIN FILMS” from DuPont Teijin Films U.S. Limited |
| | Partnership, Hopewell, Virginia. |
| PMMA1 | A conventional 7 mil (178 micron) thick poly(methyl |
| | methacrylate) film. |

### Test Methods and Preparation Procedures

### Optical Property Test

The optical properties, % transmission and % reflection of various film samples were measured using a HunterLab Ultrascan Pro from Hunter Associates Laboratory, Inc., Reston, Va. Samples were scanned at wavelengths from 350 nm to 800 nm. Film samples, about 80 mm×80 mm were mounted in the apparatus. If the sample had a reflecting layer and an opaque layer, the reflecting layer was mounted such that it faced the incident light. If the sample had only an opaque layer coated on a backing, i.e. no reflecting layer, the opaque layer was mounted such that it faced the incident light.

### Coating Procedure

Various backings, including ESR2, PET1 and PMMA1, were coated with Disp1 and Disp2 using the following coating procedure. A sheet of backing about 6 inches (15.2 cm)×18 inches (45.7 cm) was coated with the appropriate dispersion using a #3 Meyer rod. The coated sheet was allowed to dry at room temperature for at least 12 hours. After drying, the coating thickness of Disp 1, was about 0.15 mil (3.8 micron). After drying, the coating thickness of Disp2 was about 0.15 mil (3.8 micron). When ESR2 film was used as the backing, the premask was removed and the exposed surface was coated with the appropriate dispersion.

### Preparation of Film Substrate1

Film Substrate1 was prepared by coating ESR2 with Disp 1, using the coating procedure described above, to produce a film substrate having both a reflective layer, ESR2, and an opaque layer, dried Disp 1.

### Preparation of Film Substrate2

Film Substrate2 was prepared by coating ESR2 with Disp2, using the coating procedure described above, to produce a film substrate having both a reflective layer, ESR2, and an opaque layer, dried Disp2.

### Comparative Examples 1-3 (CE-1, CE2 and CE-3)

CE-1 was PET1, as received. CE-2 was PET1 coated with Disp1, using the coating procedure described above. CE-3 was PET1 coated with Disp2, using the coating procedure described above.

### Comparative Examples 4-6 (CE-4, CE5 and CE-6)

CE-4 was PMMA1, as received. CE-5 was PMMA1 coated with Disp1, using the coating procedure described above. CE-3 was PMMA1 coated with Disp2, using the coating procedure described above.

### Example 7

A piece of OCA8146-1, having dimensions of about 70 mm×100 mm, was hand laminated to a glass plate having similar length and width and a thickness of about 1 mm. The adhesive of OCA8146-1 is a pressure sensitive adhesive with two release liners having different release properties. The release liners of OCA8146-1 include an “easy” release liner, i.e. a release liner requiring a lower release force than the other release liner of OCA8146-1. During the procedure, the “easy” release liner was removed from OCA8146-1 and the exposed surface of the pressure sensitive adhesive was laminated to the glass plate. The second release liner of OCA8146-1 was not removed at this time. A piece of Film Substrate1 was cut to similar dimensions. A rectangular cavity, having dimensions of about 56 mm×84 mm was cut in Film Substrate1 using a conventional die cutting technique. The second release liner of OCA8146-1 was removed and Film Substrate1, with cavity, was hand laminated to the exposed adhesive surface of OCA8146-1, producing a border, comprising Film Substrate 1, around the outer edge of the OCA8146-1/glass plate laminate, producing Example 7. In Example 7, OCA8146-1 was laminated to the opaque coating side of Film Substrate 1. Application of sufficient pressure during lamination enabled greater than 30% of the cavity volume to be filled by OCA8146-1.

### Example 8

A second adhesive, OCA8187, having dimensions of about 70 mm×100 mm, was laminated to the exposed, reflective surface of ESR2 of Example 7 by removing the “easy” release liner of OCA8187 and hand laminating the exposed surface of the adhesive to the reflective surface of ESR2, producing Example 8. Note that the adhesive of OCA8187 is a pressure sensitive adhesive with two release liners having different release properties. During the laminating procedure, the exposed adhesive surfaces of OCA8146-1 and OCA8187, in the cavity region of Film Substrate 1, were also laminated together. The two adhesives, OCA8146-1 and OCA8187, filled at least 95% of the cavity volume.

### Example 9

Example 9 was prepared identically to Example 7, except Film Substrate2 was used in place of Film Substrate 1.

### Example 10

Example 10 was prepared identically to Example 8, except Example 9 was used in place of Example 7. The two adhesives, OCA8146-1 and OCA8187, filled at least 95% of the cavity volume.

### Example 11

A piece of Film Substrate1, having dimensions of about 57 mm×109 mm, with a cavity size of 51 mm×78 mm, was hand laminated to a similar sized piece of OCA8146-1 (no cavity) with the “easy” release liner removed, producing Example 11. The adhesive was adhered to the opaque coating side of Film Substrate1. Application of sufficient pressure during lamination enabled greater than 30% of the cavity volume to be filled by OCA8146-1.

### Example 12

In order to protect the exposed adhesive in the cavity region of Example 11 from dust and/or particulates, the “easy” release liner that was removed from OCA8146-1 of Example 11 was hand laminated back on to the exposed adhesive surface, producing Example 12.

### Example 13

A piece of Film Substrate1, having dimensions of about 57 mm×109 mm with a cavity size of 51 mm×78 was hand laminated to a similar sized piece of OCA8146-1 (no cavity) with the “easy” release liner removed. The adhesive was adhered to the opaque coating side of Film Substrate 1. A piece of OCA8187, of similar length and width of Film Substrate 1, with the “easy” release liner removed, was then hand laminated to the exposed reflective surface of Film Substrate1, producing Example 13. During the second lamination step, the exposed adhesive surfaces of OCA8146-1 and OCA8187, in the cavity region of Film Substrate1, were also laminated together. The two adhesives, OCA8146-1 and OCA8187, filled at least 95% of the cavity volume.

### Example 14

Using the laminate of Example 13, the remaining release liner of OCA8146-1 was removed and the laminate construction was hand laminated to a glass plate having dimensions of about 57 mm×109 mm×1 mm, producing Example 14.

### Example 15

A piece of Film Substrate 1 was hand laminated to a piece of OCA8146-1 with the “easy” release liner removed. The adhesive was adhered to the opaque coating side of Film Substrate1.

### Example 16

A piece of Film Substrate2 was hand laminated to a piece of OCA8146-1 with the “easy” release liner removed. The adhesive was adhered to the opaque coating side of Film Substrate2.

Using the optical property test described above, the average transmission between the wavelengths of 450 nm and 750 nm and the average reflection between the wavelengths of 450 nm and 750 nm were measured for ESR2, Film Substrate1, Film Substrate2, CE through CE6 and Examples 15 and 16. Results are shown in Table 1.

TABLE 1

| | Average Transmission | Average Reflection |
|---|---|---|
| | between 450 nm to | between 450 nm to |
| Sample | 750 nm (%) | 750 nm (%) |
| ESR2 | 1.3 | 99.0 |
| Film Substrate 1 | 1.1 | 98.9 |
| Film Substrate 2 | 0.005 | 98.5 |
| CE1 | 88.2 | 11.7 |
| CE2 | 36.5 | 63.4 |
| CE3 | 0.006 | 6.9 |
| CE4 | 89.5 | 8.6 |
| CE5 | 23.5 | 75.9 |
| CE6 | 0.007 | 6.8 |
| Example 15 | 1.2 | — |
| Example 16 | 0.006 | — |

The data of Table 1 shows that Film Substrate1 and Film Substrate2, both of which include a reflecting layer and an opaque layer, provided low transmission and high reflection of electromagnetic radiation between the wavelengths of 450 nm and 750 nm. Each of the adhesive articles of Examples 15 and 16, which included Film Substrate1 and Film Substrate2, respectively, also exhibited low transmission of electromagnetic radiation between the wavelengths of 450 nm and 750 nm and contained a reflecting layer which reflects greater than 98% of electromagnetic radiation between the wavelengths of 450 nm and 750 nm. By contrast, none of the Comparative Examples, which did not include at least one of a reflecting layer or an opaque layer, were able to provide both low transmission and high reflection of electromagnetic radiation between the wavelengths of 450 nm and 750 nm.

Although the present invention has been described with reference to preferred embodiments, workers skilled in the art will recognize that changes may be made in form and detail without departing from the spirit and scope of the invention.

1. An adhesive article comprising:
a film substrate comprising:
a reflecting layer having first and second major surfaces, wherein incident electromagnetic radiation between the wavelengths of about 450 nm and about 750 nm reflecting from at least the first major surface of the reflecting layer has an average reflection of greater than about 50%; and
an opaque layer having first and second major surfaces, wherein the second major surface of the opaque layer is positioned adjacent to the second major surface of the reflecting layer; and
a first adhesive,
wherein the film substrate has an average transmission of less than about 20% of electromagnetic radiation between the wavelengths of about 450 nm and about 750 nm,
wherein the film substrate includes a cavity extending from the first major surface of the reflecting layer to the first major surface of the opaque layer, and
wherein a volume of the cavity is at least partially filled by the first adhesive.

2. The adhesive article of claim 1, wherein the first adhesive is disposed on at least a portion of one of the first major surface of the reflecting layer and the first major surface of the opaque layer.

3. The adhesive article of claim 2, wherein the opaque layer is an opaque film, an opaque coating or a combination thereof.

4. The adhesive article of claim 2, wherein the reflecting layer is a multi-layer optical film, a mirror film or a combination thereof.

5. The adhesive article of claim 4, wherein the reflecting layer is a multi-layer optical film and wherein the multilayer optical film has between about 2 layers and 10,000 layers.

6. The adhesive article of claim 2, wherein the film substrate has an average transmission of less than about 10% of electromagnetic radiation between the wavelengths of about 450 nm and about 750 nm.

7. The adhesive article of claim 2, wherein incident electromagnetic radiation between the wavelengths of about 450 nm and about 750 nm reflecting from at least the first major surface of the reflecting layer has an average reflection of greater than about 90%.

8. The adhesive article of claim 2, wherein the film substrate has a thickness of between about 5 microns and about 250 microns.

9. The adhesive article of claim 2, wherein the opaque layer has a thickness of between about 0.5 micron and about 200 microns.

10. The adhesive article of claim 2, wherein the first adhesive is an optically clear adhesive.

11. The adhesive of claim 2, wherein the first adhesive is selected from at least one of a pressure sensitive adhesive, a structural or elastomeric thermoset adhesive and a heat activated adhesive.

12. The adhesive article of claim 2, wherein the cavity volume is substantially filled by the first adhesive.

13. The adhesive article of claim 2, further comprising a second adhesive, wherein the second adhesive is disposed on at least a portion of one of the first major surface of the reflecting layer and the first major surface of the opaque layer.

14. The adhesive article of claim 13, wherein the cavity is at least partially filled by the second adhesive.

15. The adhesive article of claim 13, wherein the cavity is substantially filled by the first adhesive and the second adhesive.

16. A display component comprising the adhesive article of claim 2 having a first display element adhered to the first adhesive of the adhesive article.

17. The display component of claim 16, wherein the first display element is selected from one of a display module, camera module, protective layer, polarizer, optical filter, anti-reflective film, hard coat film, contrast enhancement film, privacy film and EMI/RF shielding layer.

18. The display component of claim 16, further comprising a second adhesive and a second display element adhered to the second adhesive, wherein the second adhesive is disposed on at least a portion of one of the first major surface of the reflecting layer and the first major surface of the opaque layer.

19. The display component of claim 18, wherein the second display element is selected from one of a display module, camera module, protective layer, polarizer, optical filter, anti-reflective film, hard coat film, contrast enhancement film, privacy film and EMI/RF shielding layer.

20. A method for producing a display component comprising:
providing the adhesive article of claim 2;
providing a first display element; and
adhering the first display element to the first adhesive of the adhesive article.
